(19) United States
(12) Patent Application Publication
(10) Pub. No.: US 2009/0025998 A1
(43) Pub. Date: Jan. 29, 2009

(54) Arrangement for Determining an Absolute Tilt Angle in Relation to the Horizontal

(75) Inventors: Thomas Brandmeier, Wenzenbach (DE); Michael Feser, Barbing (DE); Christian Lauerer, Manching (DE); Jens Paggel, Abensberg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/088,291

(22) PCT Filed: Sep. 28, 2006
(86) PCT No.: PCT/EP2006/066853

§ 371 Date: Jul. 11, 2008

(30) Foreign Application Priority Data
Sep. 30, 2005 (DE) 10 2005 047 021.1

(51) Int. Cl. B60K 28/14

(52) U.S. Cl. 180/282

(57) ABSTRACT

A system determines an absolute tilt angle in relation to the horizontal, especially for use in a motor vehicle. The system includes at least one sensor element having a main axis of sensitivity and disposed such that its main axis of sensitivity lies in the plane of the tilt angle to be detected. The at least one sensor element produces a sensor signal depending on the tilt angle in relation to the horizontal. The sensor signal is a measured acceleration of the system. The system also includes a device for detecting an acceleration component of the measured acceleration and a processing unit to which the measured acceleration and the acceleration component are supplied in order to determine an acceleration component-corrected acceleration from which the absolute tilt angle of the system in relation to the horizontal can be determined.

The invention relates to an arrangement for determining an absolute tilt angle in relation to the horizontal comprising at least one sensor element, which has a main axis of sensitivity, with the at least one sensor element being arranged in such a manner that it's main axis of sensitivity lies in the plane defined by the tilt angle to be detected (tilt plane) and the at least one sensor element producing a sensor signal as a function of the tilt angle in relation to the horizontal.

The detection of the absolute tilt angle is extremely important for instance in respect of reliably detecting a motor vehicle turning over for instance. The main problem with detecting a motor vehicle turning over, in addition to the long timescale during which the event takes place, is the angle of the motor vehicle in relation to the horizontal.

This angle, which is also referred to as motor vehicle or roll angle, was previously determined by integration over a measured angle speed (so-called roll speed or rotational speed) over the motor vehicle longitudinal axis (so-called roll axis). The precision of the result for this integration is determined by two unknown factors: the start value of the integral and the sensor zero point of a rotational speed sensor used to determine the rotational speed. To complicate matters further in practice, all real rotational speed sensors have a zero-point drift.

The zero-point drift of the sensor is generally determined by a very slow low pass filter. This is based on the assumption that during normal use the motor vehicle does not permanently rotate in one direction about the roll axis. This procedure provides correct results as long as the motor vehicle moves in a “two-dimensional world”. If however due to driving up and downhill the motor vehicle moves in the area with a simultaneous steering movement, an error in the measurement of the roll angle is produced as a matter of principle during the use of an individual rotational speed sensor. This measurement error can only be eliminated by using three rotational speed sensors, as a result of which the costs for the sensor arrangement become very high. Even if the zero point of the rotational speed sensor is well known, the start value of the integral remains an unknown factor.

Known solutions to the problem rely on the motor vehicle generally being disposed horizontally during normal operation, which is why the motor vehicle angle should on average be equal to zero over a longer period of time, e.g. several seconds. Overturning events do not only take place in normal road traffic, but also in the country. When driving in the country, it cannot be assumed that the motor vehicle averages a horizontal position during a longer period of time. A slower low pass than an integral feedback can therefore result in false estimations of the situation, thereby causing an occupant protection means in some circumstances not to activate or to activate at the wrong time. Longer journeys with a transversal tilt provide an example here. It cannot be ruled out here that a correspondingly large transversal tilt angle is ‘forgotten’ after a sufficiently long time.

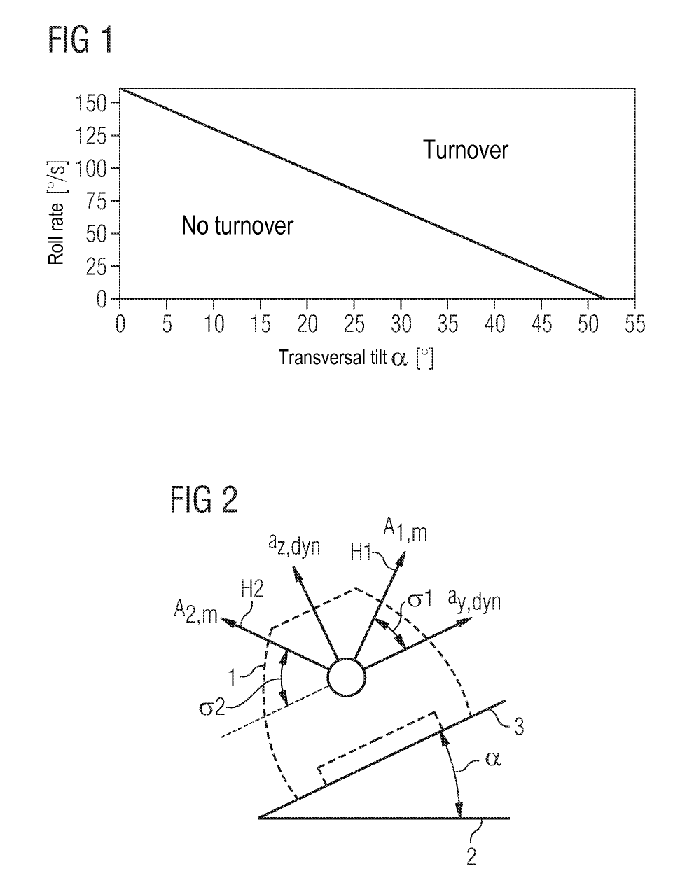

FIG. 1 shows the roll rate required for the motor vehicle to turn over as a function of the transversal tilt and thus of the motor vehicle angle in relation to the horizontal. The roll rate required for the motor vehicle to turn over decreases as the motor vehicle angle increases. If the motor vehicle angle of the motor vehicle is unknown in relation to the horizontal, it is not possible to reach a reliable decision in respect of triggering an occupant protection system or a motor vehicle stabilizing system.

DE 44 36 379 A1 discloses a sensor arrangement for detecting a specific tilt angle. The sensor arrangement consists of at least two sensor elements, with these being arranged in such a manner that their main axes of sensitivity lie in the plane defined by the tilt angles to be detected (tilt planes) and each form an angle in respect of a reference plane of the arrangement, which corresponds to the tilt angles to be detected. Each sensor element produces a sensor signal as a function of the tilt angle of the reference plane in relation to the horizontal direction. The sensor elements are arranged with their main axis of sensitivity at such an angle in relation to the horizontal, which corresponds to the tilting angle of the arrangement integrated in a motor vehicle for instance. This means that the main axis of sensitivity of a sensor element is then precisely horizontal, if the motor vehicle is disposed in the right and/or left tilting position. A sensor signal is then output as a matter of principle by the setup of the sensor elements, if the motor vehicle has reached this tilting position.

The sensor arrangement described in DE 44 36 379 A1 is thus able to detect an absolute angle of the motor vehicle in relation to the horizontal, however the detection is restricted to a single angle, which is determined by the arrangement of the main axes of sensitivity of the sensor elements.

It is thus the object of the present invention to specify an arrangement to determine an absolute tilt angle in relation to the horizontal, which does not comprise the afore-mentioned disadvantages.

This object is achieved by an arrangement for determining an absolute tilt angle with the features of claim 1. Advantageous embodiments result from the dependent claims.

An inventive arrangement for determining an absolute tilt angle, which is subsequently also referred to as absolute angle, has at least one sensor element comprising one main axis of sensitivity. The at least one sensor element is arranged in such a manner that its main axis of sensitivity lies in the plane defined by the tilt angle to be detected (tilt plane) and the at least one sensor element produces a sensor signal as a function of the tilt angle in relation to the horizontal. The sensor signal supplied by the sensor element is a measured acceleration of the arrangement. Provision is also made for a device for determining an acceleration component of the measured acceleration and for a processing unit, to which the measured acceleration and the acceleration components can be supplied in order to determine an acceleration corrected by the acceleration component, from which the absolute tilt angle of the arrangement in relation to the horizontal can be determined.

The invention can be used inter alia in a means of transportation, in particular in a motor vehicle in conjunction with an occupant protection system, with the absolute tilt angle being used for the decision as to whether a protection device of the occupant protection system is triggered and/or whether measures which stabilize the motor vehicle are met.

The tilt plane spanned and/or defined by the at least one sensor element is horizontal in relation to a motor vehicle axis of the motor vehicle. According to this, the tilting axis to be monitored of the motor vehicle is parallel to the direction of travel of the motor vehicle.

The arrangement according to the invention enables the actual tilt angle in relation to the horizontal to be determined, i.e. irrespective of the criticality of the tilt angle in respect of an unstable driving situation or an imminent turnover. It is thus possible to detect not just one individual angle, such as for instance the tilting angle in DE 44 36 379 A1, but it is instead possible to specify the angle in relation to the horizontal at any point in time during the movement, even when the arrangement is idle.

According to a preferred embodiment, the acceleration component is determined in one direction, which deviates from a movement direction of the arrangement. The movement direction corresponds to the driving direction of the motor vehicle for instance.

According to a further preferred embodiment, the acceleration component is a transverse acceleration of the arrangement moved in the movement direction. The transverse acceleration corresponds to the centrifugal acceleration occuring during a dynamic driving situation of the motor vehicle, by which proportion the acceleration measured by the at least one sensor device is corrected. The measured acceleration is attributed to the proportion of the vertical dynamics and the gravitational acceleration, from which the absolute angle of the arrangement and/or the motor vehicle can be determined with a high degree of accuracy.

The acceleration component can be determined in different ways, e.g. measured or calculated. In this way, measured values already determined using sensors can be used here in particular in a motor vehicle at different points, as a result of which the realization of the invention is possible in a cost-effective fashion without additional components. To this end, the device for determining the acceleration component according to a further preferred embodiment is designed to determine these from at least one of the following parameters:
the speed of the arrangement;
a curve radius, on which the arrangement is located;
a yaw rate;
a steering angle.

This information is provided for instance by an ABS (Anti-lock Braking System) and/or an ESP (Electronic Stability Program) sensor system. Information pertaining to the wheel speed and if necessary the speed can be used by the ABS sensor system to calculate the transverse acceleration. The ESP sensor system can query the yaw angle change and longitudinal speed and also potentially the steering angle and use them to calculate the transverse acceleration.

According to a further preferred embodiment, the at least one sensor element is arranged with its main axis of sensitivity at an angle in the tilt plane in relation to the horizontal, as a result of which an improved measurement accuracy of the measured acceleration and thus of the absolute angle determined therefrom can be achieved.

According to a further preferred embodiment, a first sensor element is provided with a first main axis of sensitivity and a second sensor with a second main axis of sensitivity. An intrinsic correction of the sensor drift can be obtained with two sensor elements, if this has the same sign for both sensors. In the worst case with an oppositely positioned sensor drift, the error is as great as the measured value determined using an individual sensor.

According to a further preferred embodiment, the absolute tilt angle α of the arrangement in relation to the horizontal is calculated according to the formula

$$\begin{matrix}α = \frac{{A}_{1} - {A}_{2}}{{A}_{1} + {A}_{2}} \\ whereby & ( 1 ) \\ {A}_{1} = {A}_{1 , m} - \frac{1}{\sqrt{2}} \cdot {a}_{y , dyn} & ( 2 ) \\ {A}_{2} = {A}_{2 , m} + \frac{1}{\sqrt{2}} \cdot {a}_{y , dyn} & ( 3 )\end{matrix}$$

and
A_{1,m} is the acceleration measured by the first sensor element;
A_{2,m} is the acceleration measured by the second sensor element;
α_{y,dyn} is the acceleration component;
A₁ is the corrected acceleration of the first sensor element;
A₂ is the corrected acceleration of the second sensor element;
α is the absolute tilt angle.

The motor vehicle angle α in relation to the horizontal can be determined by the measured gravitational accelerations A1 and A2 of the two sensor elements according to (1), with (1) applying in this general form to the arrangement and/or motor vehicle idling and driving in a straight line. In dynamic driving situations, the centrifugal acceleration of the motor vehicle must be taken into account. The centrifugal acceleration can be determined from the measurement signals described above e.g. the ABS or ESP sensor system. If the acceleration component α_{y,dyn} produced in a driving dynamic manner is known, the measured transverse acceleration (A_{1,m} of the first sensor element and A_{2,m} of the second sensor element) can be reduced in a dynamic driving situation (e.g. rapid bend driving) by the ‘dynamic’ components and the remaining static acceleration (A1 and/or A2) can be used for the angle calculation. The absolute angle of the motor vehicle can be determined in this way.

According to a further preferred embodiment, the first main axis of sensitivity of the first sensor element and the second main axis of sensitivity of the second sensor element are arranged at an angle of 90° in respect of one another. Further preferably, the first main axis of sensitivity of the first sensor element and the second main axis of sensitivity of the second sensor element each adopt an angle of 45° in relation to the vertical of the arrangement, if the absolute tilt angle in relation to the horizontal is 0°. The two sensor elements determine, if the motor vehicle is idling and horizontal, the same measured value. The change in the measured value is linear in the angle variation of the motor vehicle in relation to the horizontal. Two advantages are achieved herewith: on the one hand, the sensor signal is linear in the measured variable and on the other hand two signals are compared in order to determine a parameter. This redundancy increases the accuracy in the measurement of the acceleration of the motor vehicle. A measured value which is linear in the angle is however also already available with a sensor element.

In driving dynamic borderline situations, these are to be identified as situations in which the procedure according to the invention reaches its limits. The absolute angle calculation must be discarded and a conventional angle calculation over the rotational speed has to be implemented. According to a further preferred embodiment, this also has a further device for tilt angle calculation, which is designed so as to perform an integration over a rotational speed determined by a rotational speed rate sensor. As driving dynamic borderline situations are generally shorter and the method of angle calculation for short time intervals is really precise, the error-prone integration does not present any disadvantages.

The absolute angle determined the last is used as a start value for the integration of the speed rate, in accordance with a further preferred embodiment, said absolute angle being determined as described above. As a result, a higher degree of accuracy in terms of angle determination in relation to conventional methods is ensured.

According to a further preferred embodiment, a change-over device is provided, which determines according to predetermined criteria whether the tilt angle of the arrangement in relation to the horizontal is to be determined or not by the further device using rotational speed signals and whether the second device is accordingly activated or not.

The invention is described in more detail below with reference to the exemplary embodiments specified in the drawings, in which:

FIG. 1 shows the roll rate required for a vehicle to turn over as a function of the motor vehicle angle in relation to the horizontal;

FIG. 2 shows a schematic illustration of a motor vehicle from the rear, having a sensor element pair in a position which is inclined in relation to the horizontal;

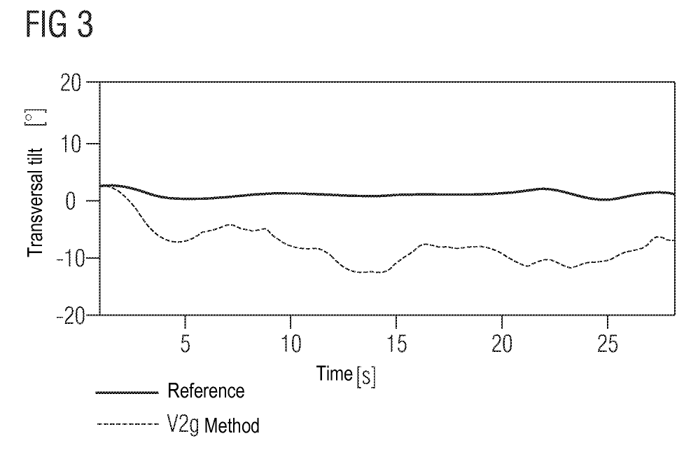

FIG. 3 shows the course of determined transversal tilts of the motor vehicle over time, which contrasts an uncompensated tilt angle determination with a reference method;

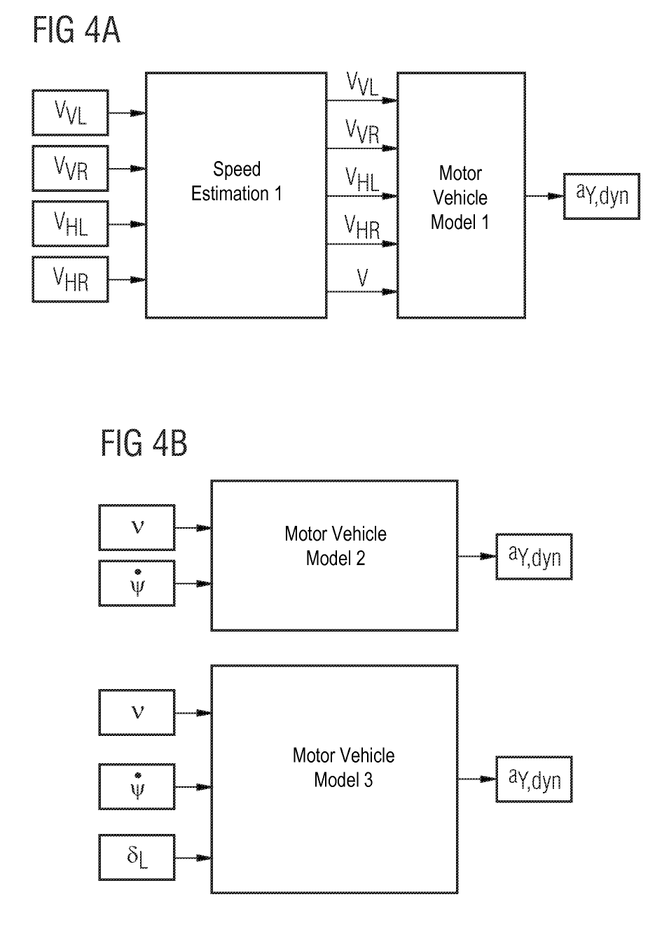

FIG. 4a shows an illustration of a first motor vehicle model, according to which an acceleration component α_{y,dyn} produced in a driving dynamic manner can be determined;

FIG. 4b shows an illustration of additional motor vehicle models, according to which an acceleration component α_{y,dyn} produced in a driving dynamic manner can be determined;

FIG. 5 shows the comparison of temporal courses of the acceleration component α_{y,dyn} produced in a driving dynamic manner and determined using different motor vehicle models;

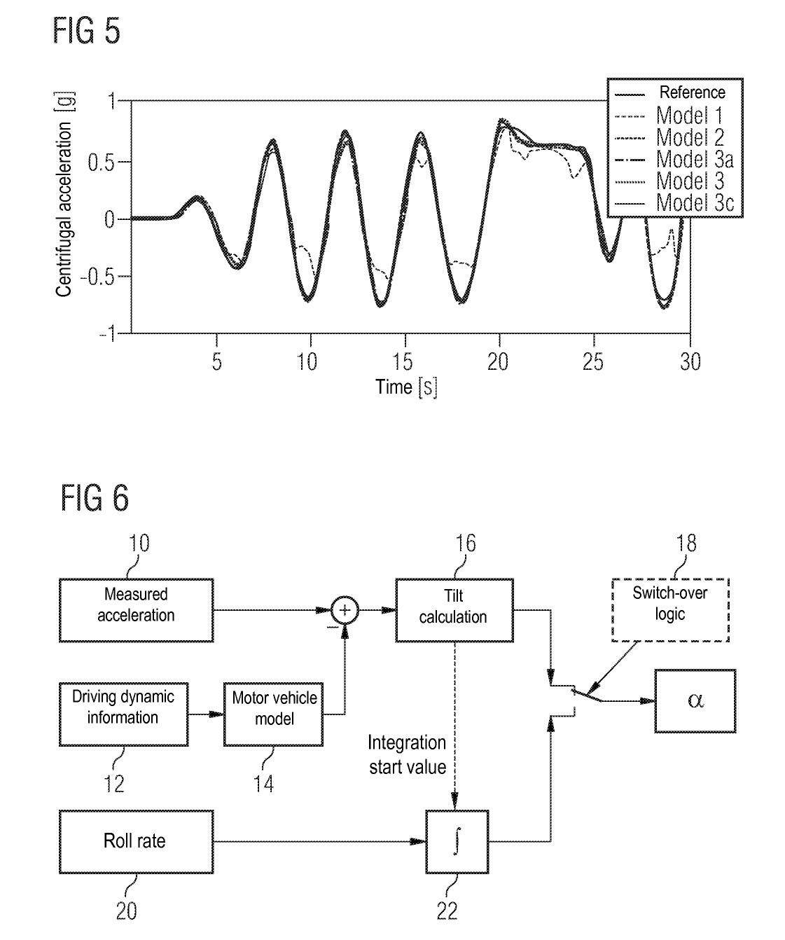

FIG. 6 shows a schematic illustration of the arrangement according to the invention, which is extended by an additional device for tilt angle calculation, and which is designed so as to perform an integration over a rotational speed determined by a rotational speed sensor;

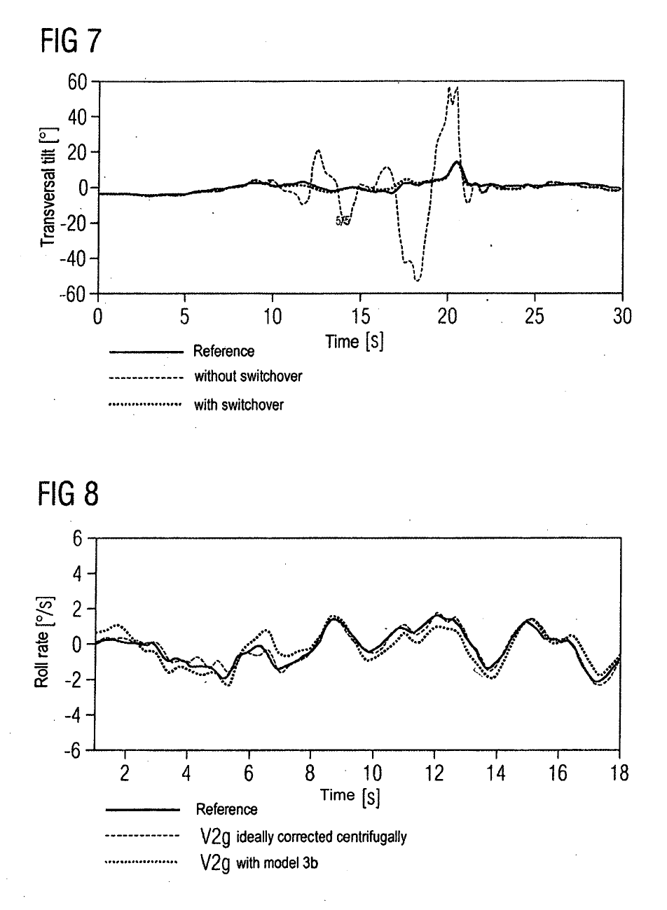

FIG. 7 shows the comparison of temporal courses of the determined transversal tilt;

FIG. 8 shows the comparison of temporal courses of the determined roll rate, which contrasts a reference method with the procedure according to the invention.

On the basis of FIG. 2, in which a motor vehicle 1 is shown in a schematic illustration from the rear, having a sensor element pair (not shown in more detail in the figure) in a position inclined by the angle α in relation to the horizontal, the determination according to the invention of the actual tilt angle α is most clear.

The sensor elements embodied as acceleration sensors have a main axis of sensitivity H1 and/or H2. The tilt plane spanned by the sensor elements and/or by their main axes of sensitivity is perpendicular to a longitudinal axis of a motor vehicle (perpendicular to the sheet plane) of the motor vehicle 1.

Accordingly, the tilting axis of the motor vehicle to be monitored runs parallel to the direction of travel of the motor vehicle.

An acceleration A_{1,m} and/or A_{2,m} is measured in each instance in the main axes of sensitivity H1 and/or H2, said accelerations being composed in each instance of a component α_{y,dyn} in the y-direction (transverse to the direction of travel and parallel to a reference plane 3) and a component a_{z,dyn} in the z-direction (perpendicular to the reference plane 3). The reference plane 3 is tilted in relation to a horizontal plane 2 by the tilt angle α to be determined.

The components acting in the direction of travel (x-direction), which is influenced by uphill and downhill travel, can be disregarded within the scope of the present invention, as their influence is minimal.

The main axes of sensitivity H1, H2 of the two acceleration sensors form an angle of 90° in relation to one another. Both acceleration sensors preferably adopt an angle σ₁, σ₂, of 45° in relation to the perpendicular of the motor vehicle and/or to the reference plane 3. Both acceleration sensors thus measure the gravitational force and an inertia acceleration in dynamic driving situations.

Contrary to the arrangement of the acceleration sensors described and illustrated here, other angles may also be selected. Furthermore, the determination of the tilt angle α is also possible with only one sensor element.

The measuring range of the acceleration sensors can be selected such that by accounting for digitalization errors and/or the potential signal resolution (determined by a signal background noise), the proportion of the gravitational force provides a sufficiently large signal during the measurement of the acceleration A_{1,m} and/or A_{2,m}.

To be able to determine the angle α, the determination of the centrifugal acceleration acting on the motor vehicle is required, which is induced by a dynamic driving situation. The centrifugal acceleration can be determined for instance by measurement signals made available by an ABS and/or ESP sensor system. In addition, other methods can also be used.

The acceleration component α_{y,dyn} produced in a driving dynamic manner can be determined from the speeds v_{VL}, v_{VR}, v_{HL} and v_{HR} of the four wheels and/or their wheel rotational speeds of the motor vehicle, as can be seen from FIG. 4a, from which the speed v of the motor vehicle and a curve radius driven thereby can be determined. The arrangement is typical of an ABS sensor system. α_{y,dyn} can then be determined by using an algorithm familiar to the person skilled in the art and referred to in the figure as motor vehicle model 1. As is apparent from FIG. 4b, the acceleration component α_{y,dyn} produced in a driving dynamic manner can also be determined from the motor vehicle speed v and the yaw rate T (above in the figure) and/or the motor vehicle speed v, the yaw rate T and the steering angle δ_{L} (below in the figure). This arrangement is typical for an ESP sensor system. α_{y,dyn} can then likewise by determined by using an algorithm familiar to the person skilled in the art and referred to in the figure as motor vehicle model 2 and/or 3.

If the acceleration component α_{y,dyn} produced in a driving dynamic manner is known, the measured transverse acceleration (A_{1,m} of the first sensor element and A_{2,m} of the second sensor element) in a dynamic driving situation (e.g. rapid bend driving) can be reduced by the ‘dynamic’ component (cf. equations (2) and (3) and the remaining static acceleration (A₁ and A₂) can be used for angle calculation (cf. equation (1)). The absolute angle α of the motor vehicle can be determined in this way.

The measured acceleration is thus attributed to the vertical dynamics and the gravitational acceleration. This remaining acceleration determines the absolute angle α of the motor vehicle with a high level of accuracy.

Differentiation also allows the roll rate or rotational speed of the motor vehicle to be determined from the absolute angle, as a result of which conventional rotational speed sensors can in principle be replaced. The dynamic vertical acceleration can be determined by the fact that the gravitational acceleration is constant.

If the motor vehicle is traveling uphill (in x-direction), errors in the order of magnitude (1-cosΦ) result, with Φ representing the tilt angle of the uphill grade. In most everyday situations, the error is negligible.

FIG. 3 shows the influence that the correction of the measured acceleration has on the transverse acceleration, in which the temporal course of the transversal tilt of a reference measurement, which was performed using a sensor, and a determination according to the invention (referred to as V2g method) are contrasted, with a compensation by α_{y,dyn} not having taken place.

FIG. 5 shows different temporal courses of centrifugal accelerations, which were determined using different motor vehicle models, and thus with different input values, as described by way of example in conjunction with FIG. 4a and FIG. 4b.

In driving dynamic borderline situations, these must be identified as those in which the inventive procedure reaches its limits. The absolute angle calculation over the measured acceleration 10, the determination of the driving dynamic information 12 and the use of a motor vehicle model to calculate α_{y,dyn} for tilt calculation 16 is rejected in such a borderline situation and a conventional angle calculation is implemented by way of a rotational speed 20 and integration 22 determined using sensors (FIG. 6). A switch-over logic 18 controls when the one or the other method is used. Criteria for a switch-over could be one or a number of the following criteria: wheel speeds of the wheels, drift angle of the motor vehicle, transverse acceleration (centrifugal acceleration) steering angle and/or start value for the integration of the angle is the last absolute angle, which was calculated by 16. As driving dynamic borderline situations generally only last a short amount of time and the method for angle calculation is very precise for short time intervals, the error-prone integration does not represent any disadvantages.

FIG. 7 shows the result of the two different calculation methods on the basis of the temporal course of the transversal tilt, with a switch-over taking place at point in time 9 sec. It can be seen easily that the absolute angle detection in borderline situations by 16 results in unusable results.

The high precision of the absolute angle detection allows the determined absolute angle to be used to determine the roll rate. FIG. 8 shows the result of the differentiation of the absolute angle in comparison with a reference sensor.

The inventive arrangement provides for a simple and cost-effective variant for absolute angle detection. No more sensor elements are needed than are required in conventional arrangements.

There is the possibility of replacing the roll rate sensor by combining two acceleration sensors, as a result of which significant cost-savings can be made.

1-13. (canceled)

14. A arrangement for determining an absolute tilt angle in relation to a horizontal, comprising:
at least one sensor element having a main axis of sensitivity and being disposed with said main axis of sensitivity lying in a plane defined by the tilt angle to be detected, said at least one sensor element producing a sensor signal in dependence on the tilt angle in relation to the horizontal, the sensor signal being a measured acceleration of the arrangement;
a device for determining an acceleration component of the measured acceleration;
a processing unit connected to receive the measured acceleration and the acceleration component for determining a corrected acceleration corrected by the acceleration component, from which the absolute tilt angle of the arrangement in relation to the horizontal can be determined.

15. The arrangement according to claim 14, configured for implementation in a motor vehicle.

16. The arrangement according to claim 15, wherein the acceleration component is determined in a direction different from a movement direction of the motor vehicle.

17. The arrangement according to claim 14, wherein the acceleration component is a transverse acceleration and/or a centrifugal acceleration of the arrangement moved in the movement direction.

18. The arrangement according to claim 15, wherein said device for determining the acceleration component is configured to determine the acceleration component from at least one of the following parameters:
a speed of the arrangement;
a curve radius, on which the arrangement is located;
a yaw rate;
a steering angle.

19. The arrangement according to claim 14, wherein said at least one sensor element is disposed with said main axis of sensitivity at an angle in the tilt plane in relation to the horizontal.

20. The arrangement according to claim 14, wherein said at least one sensor element is a first sensor element with a first main axis of sensitivity and a second sensor element with a second main axis of sensitivity.

21. The arrangement according to claim 20, wherein the absolute tilt angle α of the arrangement in relation to the horizontal is calculated according to the formula
$$α = \frac{{A}_{1} - {A}_{2}}{{A}_{1} + {A}_{2}}$$
$$with$$
$${A}_{1} = {A}_{1 , m} - \frac{1}{\sqrt{2}} \cdot {a}_{y , dyn}$$
$${A}_{2} = {A}_{2 , m} + \frac{1}{\sqrt{2}} \cdot {a}_{y , dyn}$$
where:
A_{1,m} is the acceleration measured by the first sensor element;
A_{2,m} is the acceleration measured by the second sensor element;
α_{y,dyn} is the acceleration component;
A₁ is the corrected acceleration of the first sensor element;
A₂ is the corrected acceleration of the second sensor element;
α is the absolute tilt angle.

22. The arrangement according to claim 20, wherein the first main axis of sensitivity of said first sensor element and the second main axis of sensitivity of said second sensor element extend at an angle of 90° in relation to one another.

23. The arrangement according to claim 20, wherein the first main axis of sensitivity of said first sensor element and the second main axis of sensitivity of said second sensor element each enclose an angle of 45° with a vertical of the arrangement, when the absolute tilt angle in relation to the horizontal is 0°.

24. The arrangement according to claim 14, which further comprises an additional device for tilt angle calculation, configured to perform an integration over a rotational speed determined by a rotational speed sensor.

25. The arrangement according to claim 24, wherein a last-determined absolute angle is used as a start value for the integration of the rotational speed.

26. The arrangement according to claim 24, which comprises a switch-over device configured to determine, according to predetermined criteria, whether the tilt angle of the arrangement in relation to the horizontal is to be determined or not by said additional device by using rotational speed signals and the second device is accordingly activated or not.

27. An occupant protection method in a means for transportation, the method which comprises:
providing the arrangement according to claim 14 in the means for transportation; and
considering the absolute tilt angle in a decision whether measures for stabilizing the means for transportation should be taken.

28. An occupant protection method in a motor vehicle, the method which comprises:
providing the arrangement according to claim 14 in a motor vehicle and coordinating with an occupant protection system in the motor vehicle; and
including the absolute tilt angle in a decision whether a protective device of the occupant protection system should be triggered and/or measures for stabilizing the motor vehicle should be taken.
